(19) United States
(12) Patent Application Publication
(10) Pub. No.: US 2010/0232751 A1
(43) Pub. Date: Sep. 16, 2010

(54) OPTICAL LINK MODULE AND METHOD FOR MANUFACTURING SAME

(75) Inventors: Takeshi Biwa, Fukuoka-ken (JP); Yuichi Tagami, Fukuoka-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/604,890

(22) Filed: Oct. 23, 2009

(30) Foreign Application Priority Data
Mar. 12, 2009 (JP) 2009-060231
Aug. 6, 2009 (JP) 2009-183591

(51) Int. Cl. G02B 6/36; B23P 11/00

(52) U.S. Cl. 385/93; 385/88; 29/428

(57) ABSTRACT

An optical link module, includes: a lead frame including at least two notches at an outer edge of its major surface; a substrate bonded to the major surface of the lead frame so that the notches are exposed therearound; an optical element having an optical axis generally perpendicular to the major surface and bonded onto the substrate using the notches as a positioning reference; and a receptacle housing being in contact with the lead frame to cover the substrate and the optical element, and including a tubular ferrule guide portion having a central axis generally in alignment with the optical axis and guide pins fitted into the notches.

### CROSS-REFERENCE TO RELATED APPLICATIONS

This application is based upon and claims the benefit of priority from the prior Japanese Patent Application No. 2009-060231, filed on Mar. 12, 2009 and the prior Japanese Patent Application No. 2009-183591, filed on Aug. 6, 2009; the entire contents of which are incorporated herein by reference.

### BACKGROUND OF THE INVENTION

1. Field of the Invention

This invention relates to an optical link module and a method for manufacturing the same.

2. Background Art

Use of an optical fiber to transmit/receive optical digital signals can avoid generation of electromagnetic waves and reduce the influence of electromagnetic noise, enabling high-quality signal transmission. Hence, optical link modules including optical transmitters and optical receivers are widely used in communication systems and industrial equipment control systems. Furthermore, with the increase in the amount of information, upgrading the speed of optical digital signals has been required.

In an optical link module, optical axis alignment is required in an optical transmitter between a light emitting element and an optical fiber, and in an optical receiver between a light receiving element and an optical fiber.

Optical axis misalignment causes degradation of signal waveforms and decrease in transmitted optical output. In particular, waveform degradation results in high bit error rate, which interferes with high-speed signal transmission. Thus, in high-speed signal transmission at a rate of 1 Gbps, for instance, higher accuracy in optical axis alignment is required.

JP-A-2003-227972 (Kokai) discloses an example technique related to an optical link module with improved workability and improved efficiency in optical transmission/reception. In the example, an alignment process is performed by using an optical block in which a light emitting element and a light receiving element are mounted on a semiconductor wafer with a prescribed circuit pattern formed thereon. However, it is not easy to increase the productivity of the process for forming such an optical block and the process for using the optical block to assemble an optical link module.

### SUMMARY OF THE INVENTION

According to an aspect of the invention, there is provided an optical link module including: a lead frame including at least two notches at an outer edge of its major surface; a substrate bonded to the major surface of the lead frame so that the notches are exposed therearound; an optical element having an optical axis generally perpendicular to the major surface and bonded onto the substrate using the notches as a positioning reference; and a receptacle housing being in contact with the lead frame to cover the substrate and the optical element, and including a tubular ferrule guide portion having a central axis generally in alignment with the optical axis and guide pins fitted into the notches.

According to another aspect of the invention, there is provided an optical link module including: a lead frame including at least two notches at an outer edge of its major surface; a substrate bonded to the major surface of the lead frame so that the notches are exposed therearound; an optical element having an optical axis generally perpendicular to the major surface and bonded onto the substrate using the notches as a positioning reference; a receptacle housing being in contact with the lead frame to cover the substrate and the optical element, and including a tubular ferrule guide portion having a central axis generally in alignment with the optical axis and guide pins fitted into the notches; a converging lens having an optical axis generally in alignment with the optical axis of the optical element and fitted to an opening end of the ferrule guide portion; and an optical fiber with one end portion inserted into the ferrule guide portion so as to be opposed to the converging lens, the optical fiber including a core and a cladding surrounding the core.

According to another aspect of the invention, there is provided a method for manufacturing an optical link module including a lead frame, a substrate bonded onto the lead frame, an optical element bonded onto the substrate, and a receptacle housing being in contact with the lead frame so as to cover the substrate and the optical element, the method including: bonding the substrate onto a major surface of the lead frame so that notches provided at an outer edge of the major surface of the lead frame are exposed therearound; bonding the optical element onto the substrate using each notch as a positioning reference; and fitting guide pins provided in the receptacle housing into notches so that the central axis of a tubular ferrule guide portion provided in the receptacle housing is generally aligned with the optical axis of the optical element, and fixing the lead frame to the receptacle housing.

### BRIEF DESCRIPTION OF THE DRAWINGS

FIGS. 1A and 1B are schematic views of an optical link module according to an embodiment of the invention;

FIGS. 2A to 2C are schematic views of an optical transmitter/receiver;

FIGS. 3A and 3B are schematic views of an optical transmitter/receiver according to a comparative example;

FIGS. 4A to 4E are schematic views of a converging lens;

FIGS. 5A and 5B are schematic perspective views showing the back inside of the receptacle housing;

FIGS. 6A and 6B are schematic perspective views of the backside of the receptacle housing;

FIG. 7 is a flow chart showing a method for manufacturing the optical link module;

FIGS. 8A and 8B are schematic cross-sectional views according to a variation; and

FIGS. 9A is a graph and FIGS. 9B and 9C are schematic views showing the dependence of the fall time on incident angle into the core.

### DETAILED DESCRIPTION OF THE INVENTION

Embodiments of the invention will be described with reference to the drawings.

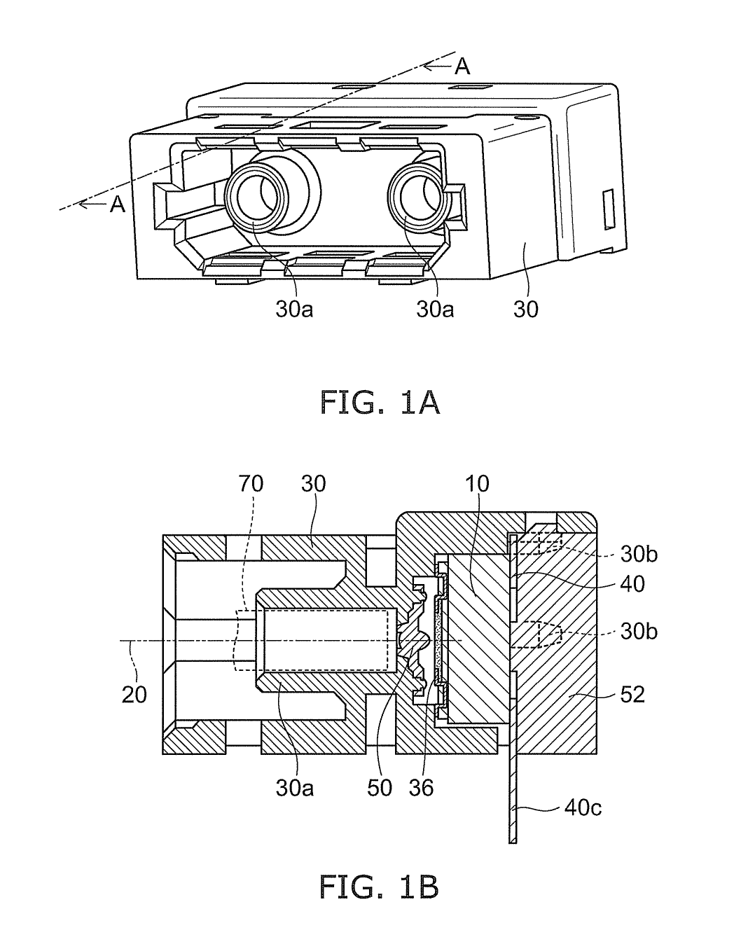

FIGS. 1A and 1B are schematic views of an optical link module according to an embodiment of the invention. More specifically, FIG. 1A is a perspective view from the front side, and FIG. 1B is a cross-sectional view taken along line A-A.

The figures show a bidirectional optical link module including an optical transmitter and an optical receiver for signals. A ferrule 70 attached to the end of an optical fiber is inserted into the optical link module from the left side in FIG. 1B to enable transmission/reception of optical signals. The module shown in the figures can be referred to as a receptacle type optical link module.

A receptacle housing 30 includes a tubular ferrule guide portion 30a so that the ferrule 70 at the end of an optical fiber can be inserted therein. Furthermore, a converging lens 50 is fixed to the receptacle housing 30 by press fitting to be opposed to the inserted ferrule 70.

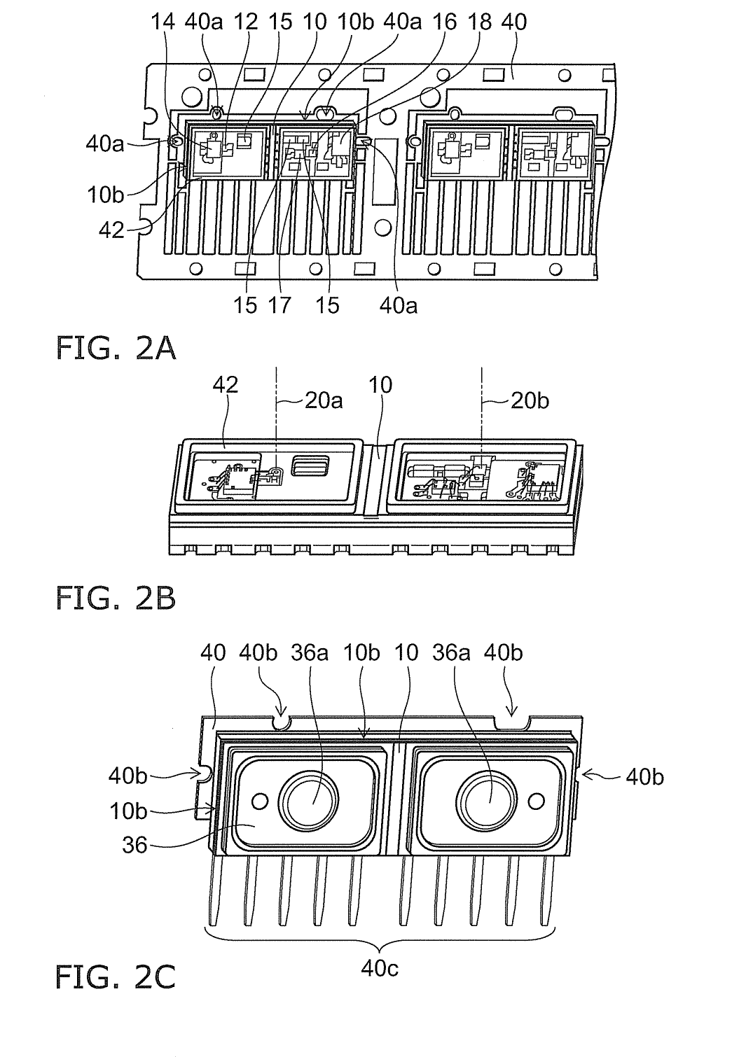

A lead frame 40 with a substrate 10 bonded thereto is attached to the backside of the receptacle housing 30, and outer leads 40c for electrical signals and power supply voltage protrude therefrom. Guide pins 30b provided in the receptacle housing 30 and notches provided in the lead frame 40 serve as a positioning reference for bonding components used for the optical transmitter and the optical receiver and a positioning reference for fixing the lead frame. The lead frame 40 with the substrate 10 bonded thereto is firmly fixed in an optical axis 20 direction by a back lid 52, which is fitted to the guide pins 30b and pressed into the receptacle housing 30. The receptacle housing 30 is provided in contact with the lead frame 40 to cover the substrate 10 and optical elements (see FIGS. 2A to 2C).

The optical link module of the invention is not limited to bidirectional optical link modules. The invention can be a transmitting optical link module in which the optical element is a light emitting element, or a receiving optical link module in which the optical element is a light receiving element. In the case of using the optical link module for industrial equipment control and short-haul communication, cost reduction is facilitated by using a multimode fiber, such as POF (plastic optical fiber) or PCF (plastic clad silica fiber), as the optical fiber.

FIGS. 2A to 2C are schematic views of an optical transmitter/receiver. More specifically, FIG. 2A is a plan view, FIG. 2B is a perspective view, and FIG. 2C shows the optical transmitter/receiver with shells bonded thereto as viewed from obliquely above.

The substrate 10 can be made of a ceramic material, such as alumina and AlN, or can be a glass epoxy substrate or the like. For instance, in the case of using alumina, the substrate 10 can be a sintered alumina multilayer with circuit interconnection formed thereon using a tungsten printing material. As shown in FIGS. 2A and 2B, a seal ring 42 illustratively made of Kovar, an iron-nickel-cobalt alloy, is bonded along the outer peripheral portion of the substrate 10 using silver solder or the like.

On the other hand, a plurality of substrates 10 are bonded, using silver solder or the like, onto the major surface of the lead frame 40, which is made of a material such as an iron-nickel alloy by press working. In the case where the substrate 10 is made of a material such as glass epoxy, the substrate 10 can be bonded with a conductive adhesive or the like.

In the embodiment, the lead frame 40 includes cutouts 40a shaped like a through hole, and vicinity of the cutouts 40a is bonded to the substrate 10 so that the neighborhoods of the cutouts 40a protrude from the outer edges 10b of the substrate 10 as shown in FIG. 2A. After lead cutting, the through-hole cutouts 40a turn to notches 40b with one end open as shown in FIG. 2C. In FIG. 2C, the notches 40b are provided at the outer edge of the major surface of the lead frame 40 after lead cutting. The notches 40b are exposed around the substrate 10.

The lead frame 40 formed by press working can readily achieve a working accuracy of approximately ±0.02 mm. Hence, each notch 40b can serve as a positioning reference for mounting (bonding) components. More specifically, the shape of each notch 40b can be optically detected, and its position can serve as a reference for bonding a light emitting element 12, a transmitting IC 14, a light receiving element 16, receiving ICs 17, 18, a capacitor 15 and the like using solder paste or other adhesive. Thus, the accuracy of the bonding position can be readily enhanced. For instance, when the optical element 12 is bonded to the substrate 10, the position of each notch 40b exposed around the substrate 10 is optically detected, and the detected position is used to determine a position for bonding the light emitting element 12. Thus, the light emitting element 12 and each notch 40b, for instance, are arranged in a fixed positional relationship.

The light emitting element 12 can be made of InGaAlP, AlGaAs, and GaAs to emit light in the visible to infrared wavelength range. The light receiving element 16 can be a Si photodiode or Si phototransistor. The light receiving element 16 can be integrated with a light receiving IC into one chip.

As shown in FIG. 2C, a shell 36, which has an optically transmissive glass window 36a illustratively made of borosilicate and is made of an alloy containing iron, nickel, cobalt and the like, can be bonded to the seal ring 42 by resistance welding or the like. Thus, the inside of the optical transmitter/receiver can be filled with nitrogen or the like and hermetically sealed.

Furthermore, each notch 40b serving as a reference for determining the fixing position is fitted and pressed to the guide pin 30b (see FIG. 1) of the receptacle housing 30. Thus, the optical axis 20a passing through the center of the light emitting element 12 and being generally perpendicular to its surface and the optical axis 20b passing through the center of the light receiving element 16 and being generally perpendicular to its surface can be positioned and fixed with high accuracy in alignment with the central axis of the ferrule guide portion 30a. This enables highly accurate alignment between the central axis of the transmitting fiber inserted into the ferrule guide portion 30a and the optical axis 20a of the light emitting element 12 and between the central axis of the receiving fiber and the optical axis 20b of the light receiving element 16. The inner diameter of the ferrule guide portion 30a can be illustratively 2.50 mm. The receptacle housing 30 can be made of a plastic material, such as PBT (polybutylene terephthalate) resin containing carbon filler.

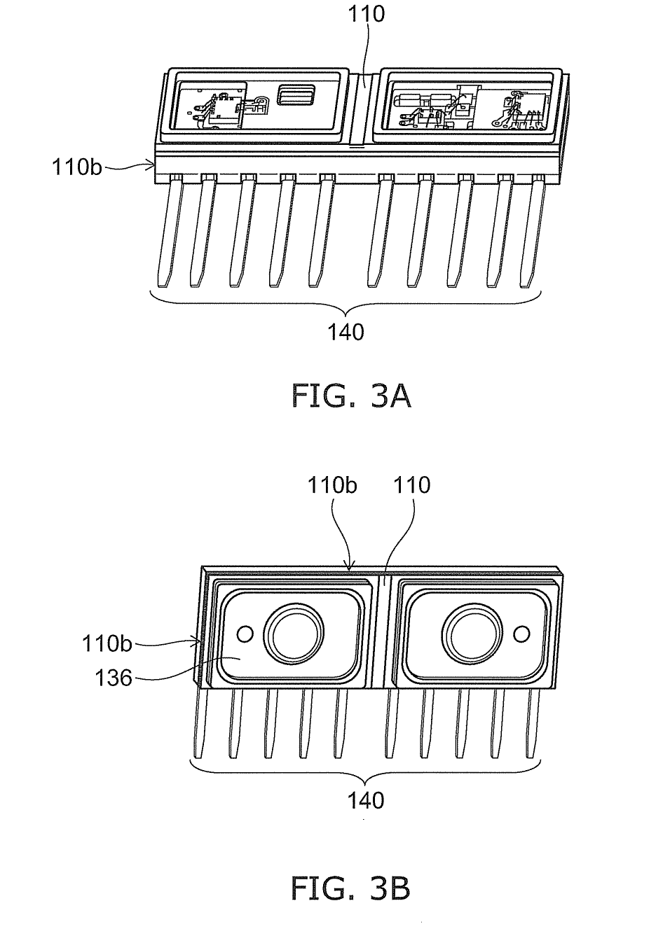

FIGS. 3A and B are schematic views of an optical transmitter/receiver according to a comparative example. More specifically, FIG. 3A is a perspective view, and FIG. 3B is a view from obliquely above.

In the comparative example, the lead frame includes outer leads 140 capable of electrical connection to the conductive layer on the rear surface of the substrate 110; however, no positioning references, such as notches, are provided.

More specifically, positioning of the receptacle housing in alignment with the optical axis of the light emitting element and the light receiving element is performed using the outer edge 110b of the substrate 110. In the case where the substrate 110 is made of alumina or other ceramic, its outline dimensional tolerance is typically as large as ±0.15 mm or more. Furthermore, the outline of the cut substrate tends to have angular variation in each of the horizontal and orthogonal directions. Hence, with reference to the outline of the substrate, it is difficult to achieve alignment between the optical axis of the light emitting element and the central axis of the transmitting fiber and between the optical axis of the light receiving element and the central axis of the receiving fiber with accuracy higher than ±0.1 mm, and optical axis misalignment is likely to occur.

Optical axis misalignment tends to cause delays at the rise and fall of signals. Specifically, waveform degradation and jitter are likely to occur, and BER (bit error rate) gets increased. Thus, high-speed transmission at a rate of 1 Gbps, for instance, is difficult to achieve. Furthermore, optical axis misalignment decreases the optical coupling efficiency between the element and the optical fiber. This requires the light emitting element to be operated at a higher current, which results in higher power consumption. Furthermore, high-current operation is undesirable because it shortens lifetime. If optical axis alignment (core adjustment) can be individually performed, these problems might be improved, but the productivity gets decreased.

In contrast, in the embodiment, the optical axis can be accurately aligned without individual optical axis alignment, and waveform degradation, transmission characteristics degradation including BER, and decrease in optical power can be prevented. High-speed transmission at a rate of 1 Gbps can easily be achieved, for instance.

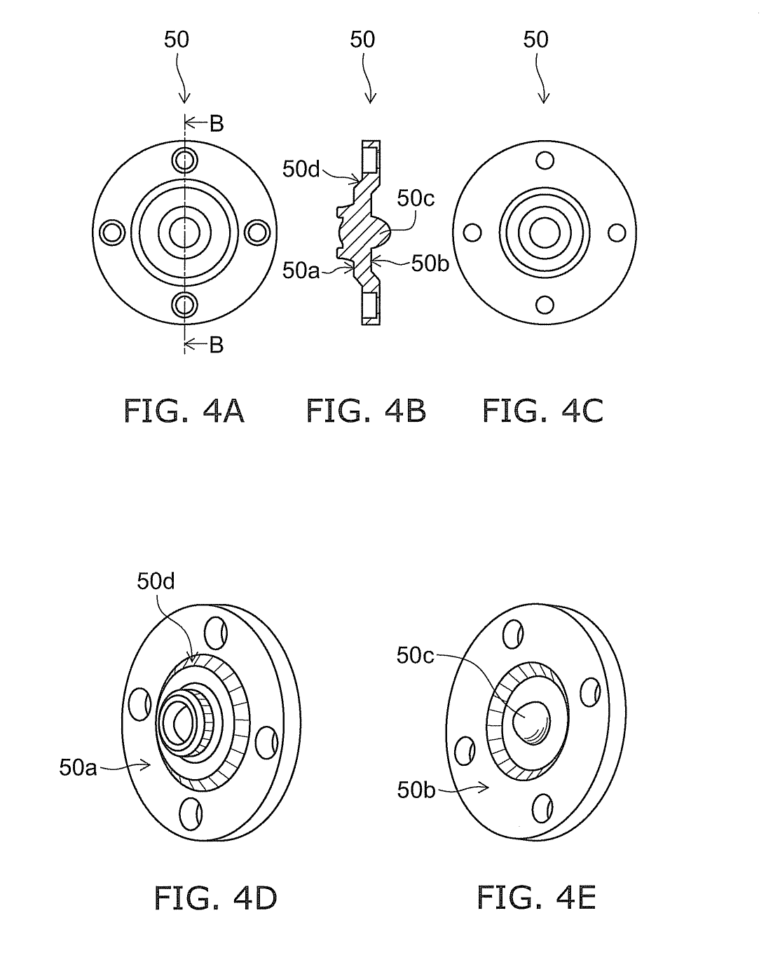

FIGS. 4A to 4E are schematic views of a converging lens. More specifically, FIG. 4A shows a first surface, FIG. 4B is a cross-sectional view taken along line B-B, FIG. 4C shows a second surface, FIG. 4D is a schematic perspective view from the first surface side, and FIG. 4E is a schematic perspective view from the second surface side.

If the converging lens 50 is made of a transparent plastic material, such as Zeox, a curved surface like a convex lens 50c can be readily formed. Furthermore, a tapered fitting hole provided in the receptacle housing 30 facilitates fitting the converging lens 50. In this case, a curved surface 50d, which can be fitted into the tapered shape of the fitting hole, can be formed in the outer peripheral portion of the first surface 50a of the lens 50. Also, hermetic sealing can be achieved by using a disk-shaped glass plate instead of the converging lens 50.

However, as shown in FIGS. 4B and 4E, the convex lens 50c formed in the second surface 50b allows emitted light from the light emitting element 12 to be efficiently converged and injected into the core of the optical fiber. Accordingly, the power consumption of the light emitting element 12 can be reduced. Furthermore, radiated light from the optical fiber can be efficiently injected into the light receiving element 16. This facilitates reception even for low optical power from the optical fiber.

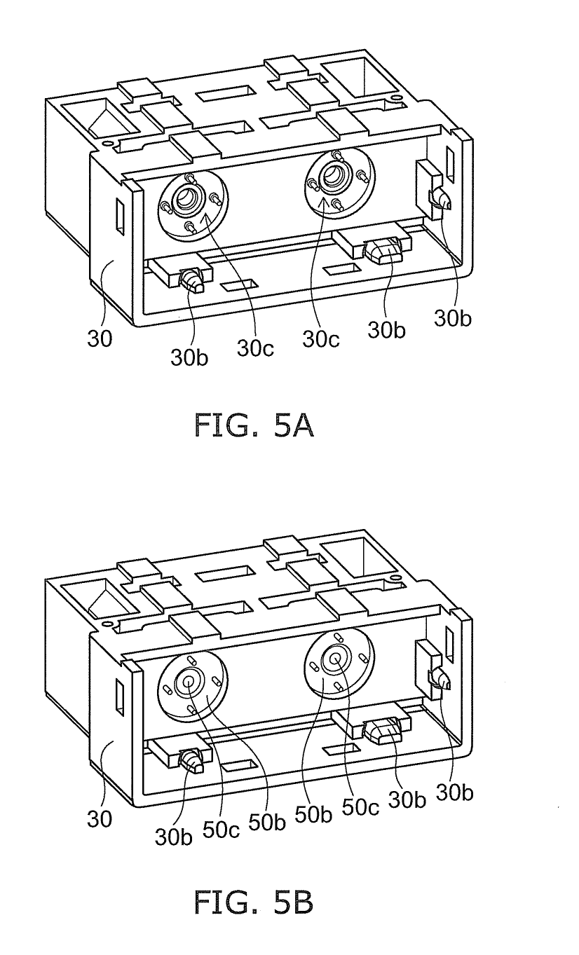

FIGS. 5A and 5B are schematic perspective views showing the back inside of the receptacle housing. More specifically, FIG. 5A is a view before press-fitting of the converging lens, and FIG. 5B is a view after press-fitting of the converging lens.

The first surface 50a side of the converging lens 50 is forcibly positioned by being press-fitted into the fitting hole 30c provided at the opening end of the ferrule guide portion 30a so that highly accurate alignment can be achieved between the receptacle housing 30 and the central axis of the converging lens 50. The converging lens 50 is preferably fixed to the receptacle housing 30 by swaging or the like.

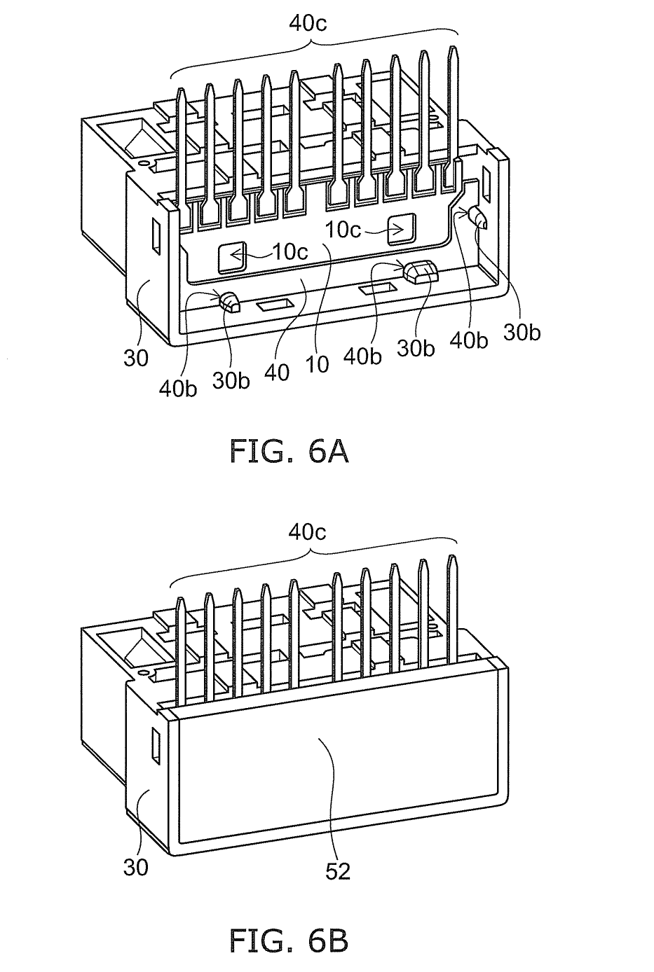

FIGS. 6A and 6B are schematic perspective views of the backside of the receptacle housing. More specifically, FIG. 6A is a view after attachment of the lead frame with the substrate bonded thereto, and FIG. 6B is a view after attachment of the back lid.

Four notches 40b provided in the lead frame 40 are respectively fitted to four guide pins 30b. Accordingly, the lead frame 40 with the substrate 10 bonded thereto is positioned inside the receptacle housing 30 with high accuracy. In FIG. 6A, the guide pin provided on the left inner wall and the notch fitted thereto are not shown. Furthermore, the lead frame 40 with the substrate 10 bonded thereto is fixed more firmly by being pressed from the backside by the back lid 52 made of PBT resin or other plastic. In the example, the lead frame 40 does not cover the entire rear surface of the substrate 10, but, as shown in FIG. 6A, the rear surface of the substrate 10 is exposed in between the portion including the notches 40b and the outer leads 40c. Thus, a recess 10c can be provided in the rear surface region of the substrate 10 where the lead frame 40 is not bonded, and the recess 10c can be fitted to a protrusion provided on the back lid 52.

Although the lead frame 40 does not cover the entire rear surface of the substrate 10 in the example, the lead frame 40 can be configured to cover the entire rear surface of the substrate 10.

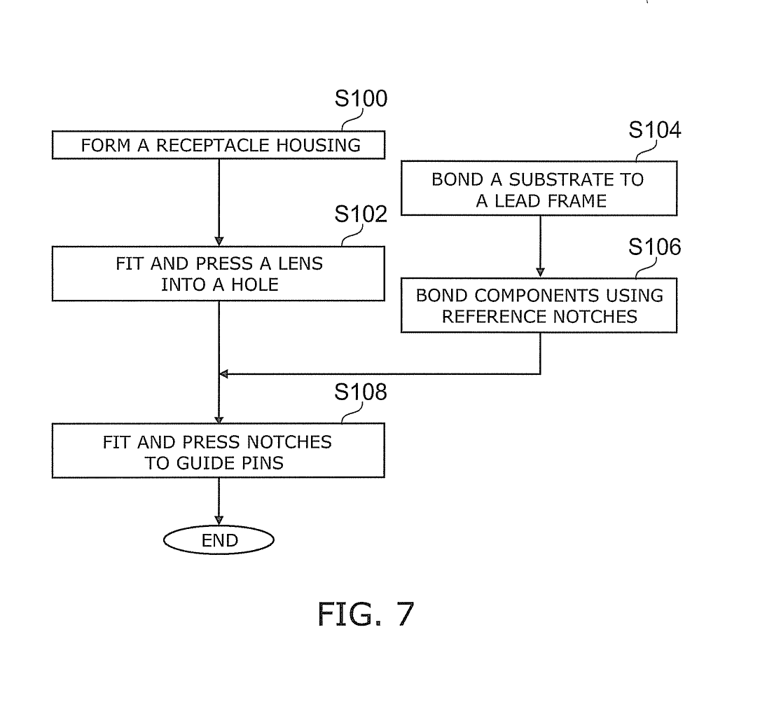

FIG. 7 is a flow chart showing a method for manufacturing the optical link module of the embodiment.

First, a receptacle housing 30 including ferrule guide portions 30a, guide pins 30b, and fitting holes 30c is formed (S100). A converging lens 50 is press-fitted into the fitting holes 30c and fixed by swaging (S102).

On the other hand, a substrate 10 is bonded to a lead frame 40 (S104). The lead frame 40 has a region protruding from the substrate 10, and the protruding region includes notches 40b. Each notch 40b serves as a positioning reference for bonding components and allows components, such as a light emitting element 12 and a light receiving element 16, to be bonded with high accuracy. This can be realized by using a method for optically or mechanically detecting the shape and position of each notch 40b (S106). Then, the position for bonding the light emitting element 12, the light receiving element 16 and the like is determined on the basis of the detected position of each notch 40b.

Furthermore, while each notch 40b is positioned by being fitted and pressed to each guide pin 30b provided on the backside of the receptacle housing 30, the substrate 10 is fixed to the receptacle housing 30 (S108). Here, two or more guide pins 30b can be provided to stably fix the substrate 10. In the embodiment, the number of guide pins 30b is four, and four notches 40b are provided to increase support points and achieve stronger fixation.

In the manufacturing method, each notch 40b provided in the lead frame 40 having a working accuracy of ±0.02 mm can be used as a reference for determining the bonding position so that the optical axes 20a, 20b of optical elements can be positioned with high accuracy. Furthermore, each notch 40b can be used as a reference for determining the fixing position so that the optical axes 20a, 20b of the optical elements can each be generally aligned with the central axes of two tubular ferrule guide portions 30a provided in the receptacle housing 30. Here, insertion of the ferrule 70 of an optical fiber into the ferrule guide portion 30a facilitate generally aligning the optical axis of the ferrule guide portion 30a with the central axis of the core of the optical fiber. Specifically, the positioning structure provided in the receptacle housing 30, such as guide pins, can be used to align the optical axes of the ferrule guide portion 30a, the converging lens 50, the light emitting element 12, and the light receiving element 16.

That is, the optical transmitter and the optical receiver can be readily made adjustment-free without individual optical axis alignment, which can increase the mass productivity of the method for manufacturing the optical link module.

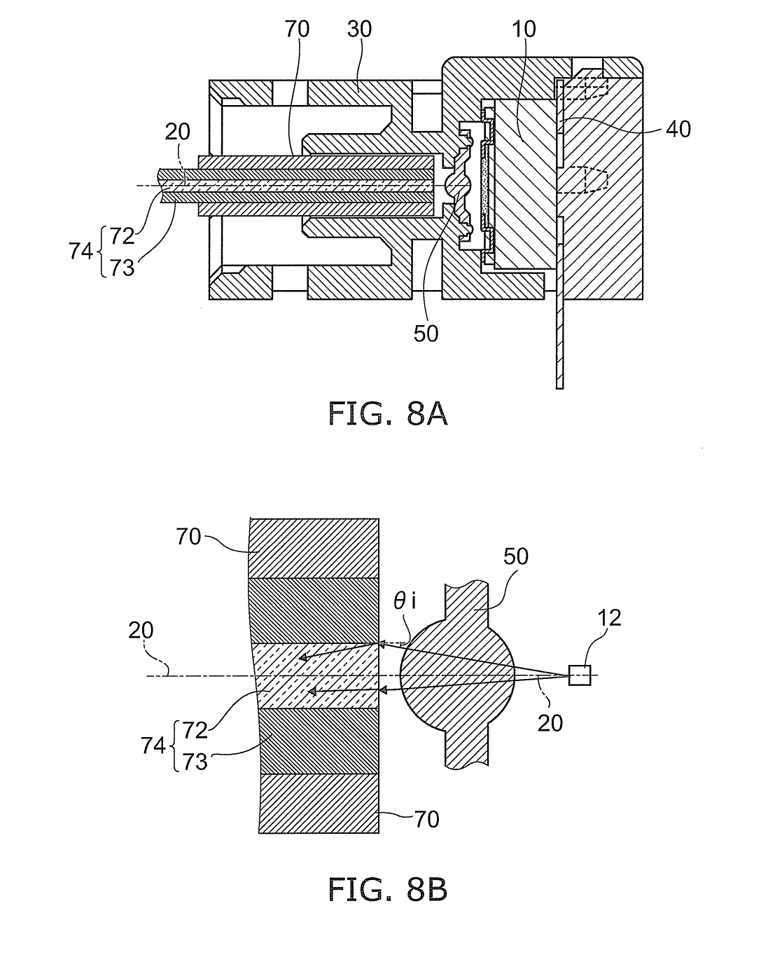

FIG. 8A is a schematic cross-sectional view according to a variation of the embodiment, and FIG. 8B is a schematic cross-sectional view illustrating incident light injected into the optical fiber core.

In an optical transmitter of the variation, emitted light from the light emitting element 12 is converged by the converging lens 50 so that the emitted light can be injected into a core 72 of the optical fiber within a prescribed range of light incident angle θi. An optical fiber 74 includes the core 72 and a cladding 73. The cladding 73 surrounding the core 72 has a lower refractive index than the core 72 so that light can be confined in the core 72. The core diameter of the optical fiber 74 is illustratively in the range from 200 to 1000 82 m, and light is transmitted in multimode. In the variation, misalignment between the optical axis 20 of the light emitting element 12 and the central axis of the core 72 of the optical fiber 74 can be readily reduced to ±100 μm or less. Thus, by suitably selecting the maximum of the light incident angle θi, mode dispersion in the optical fiber 74 can be reduced, and increase in the rise time and fall time of optical pulse signals can be prevented.

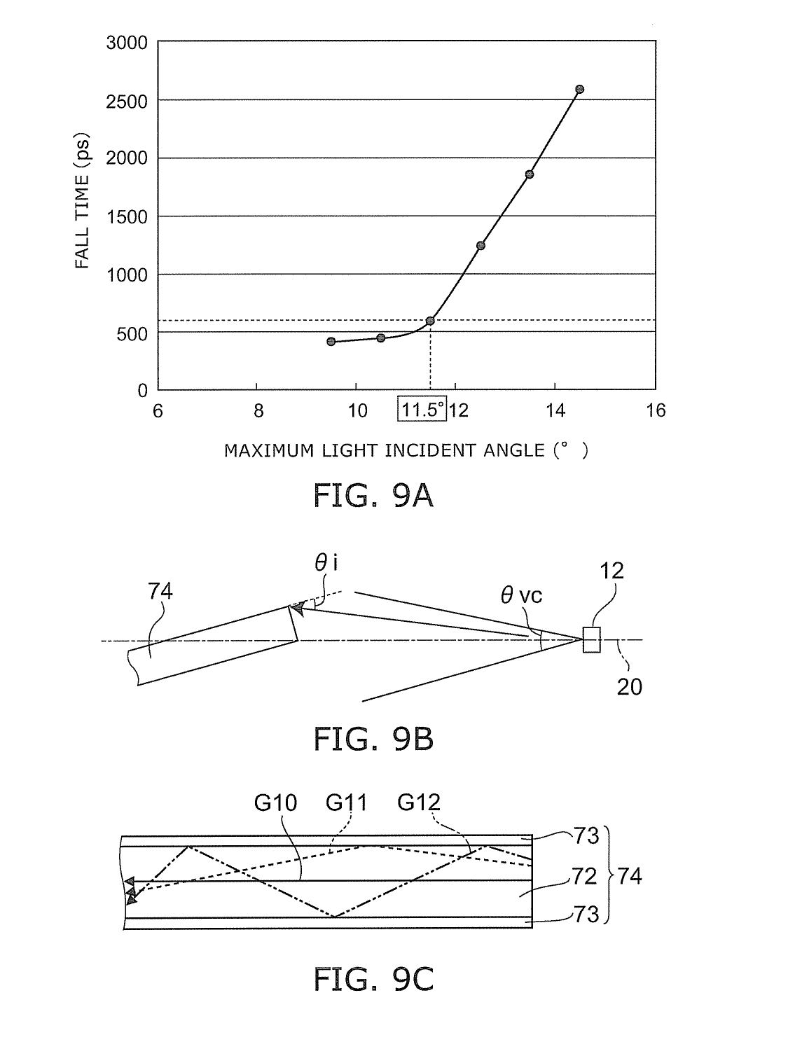

FIG. 9A is a graph showing the dependence of the fall time of optical pulse signals on the maximum of incident angle θi on the core, FIG. 9B is a schematic view illustrating the incident angle θi, and FIG. 9C illustrates mode dispersion.

In FIGS. 9A and 9B, the light emitting element 12 is assumed to be a VCSEL (vertical cavity surface emitting laser, or surface emitting semiconductor laser). It is also assumed that emitted light from the VCSEL has a Gaussian beam distribution, and the beam diameter is defined as the width where its intensity is equal to or higher than 1/e² of the intensity on the optical axis 20. The spread angle θvc of the beam diameter is defined as full width, and is illustratively 30 degrees.

In FIG. 9A, the vertical axis represents the fall time (ps) of optical pulse signals, and the horizontal axis represents the maximum light incident angle (degrees). The maximum light incident angle represents the maximum of the angle at which emitted light is incident on the end surface of the core 72 at one end of the optical fiber 74 in FIG. 9B. The fall time of optical pulse signals is as short as generally 600 ps when the maximum light incident angle is 11.5 degrees or less, but sharply increases when the maximum light incident angle exceeds 11.5 degrees. Typically, blunting in the rising waveform is smaller than blunting in the falling waveform.

In FIG. 9C, the incident light with the incident angle θi on the core end surface being equal to generally zero is labeled G10, the incident light with an incident angle θi of 11.5 degrees is labeled G11, and the incident light with the incident angle θi exceeding 11.5 degrees is labeled G12. As the incident angle θi increases, the optical path is lengthened, hence decreasing the axial propagation velocity and generating higher-order modes. Accordingly, mode dispersion is more likely to occur. Thus, at the emitting end of the core 72, the arrival time is delayed in the order of G12, G11, and G10. That is, an optical pulse signal including components with larger incident angle θi undergoes larger waveform blunting, which results in increased fall time and rise time. Here, even if the light emitting element 12 is a surface emitting diode instead of a VCSEL, the fall time sharply increases when the maximum light incident angle exceeds 11.5 degrees. In the variation, the converging lens 50 is used to narrow the maximum incident angle on the core 72 to 11.5 degrees or less. As a result, the amount of light incident on the core 72 can be readily increased while preventing mode dispersion.

The refractive index distribution of the core 72 can be either the SI (step index) type or the GI (graded index) type. For instance, by using a GI type optical fiber with a core diameter of 200 μm or less, high-speed optical pulse signals at 1.25 Gbps can be transmitted over a distance of 100 m or more while maintaining a BER of 1×10⁻¹² or less (for NRZ, and PRBS 2⁷−1).

The optical link module of the embodiment having high mass productivity can widely be used to control industrial equipment including machine tools, and for short-haul communication and the like. Furthermore, good BER can be achieved even for fast signal transmission at a rate of 1 Gbps, for instance, and high-performance control systems and communication systems can be realized.

The embodiments of the invention have been described with reference to the drawings. However, the invention is not limited to these embodiments. Those skilled in the art can variously modify the lead frame, substrate, light emitting element, light receiving element, receptacle housing, and converging lens constituting the embodiments of the invention, and such modifications are also encompassed within the scope of the invention unless they depart from the spirit of the invention.

1. An optical link module, comprising:
a lead frame including at least two notches at an outer edge of its major surface;
a substrate bonded to the major surface of the lead frame so that the notches are exposed therearound;
an optical element having an optical axis generally perpendicular to the major surface and bonded onto the substrate using the notches as a positioning reference; and
a receptacle housing being in contact with the lead frame to cover the substrate and the optical element, and including a tubular ferrule guide portion having a central axis generally in alignment with the optical axis and guide pins fitted into the notches.

2. The module according to claim 1, wherein the optical element and the notches are in a fixed positional relationship.

3. The module according to claim 1, further comprising:
a converging lens having an optical axis generally in alignment with the optical axis of the optical element,
the receptacle housing further including a fitting hole having a tapered cross-sectional shape at an opening end of the ferrule guide portion, and
the converging lens having an outer peripheral portion fitted into the fitting hole.

4. The module according to claim 1, further comprising:
a back lid sandwiching the lead frame with the receptacle housing.

5. The module according to claim 1, wherein a number of the guide pins is four.

6. The module according to claim 1, wherein a first optical element emitting light along a first optical axis and a second optical element receiving light along a second optical axis are bonded onto the substrate to enable bidirectional optical transmission.

7. The module according to claim 1, further comprising:
a shell being translucent near the optical axis,
an inside space formed by sealing the shell and the substrate being hermetic.

8. An optical link module comprising:
a lead frame including at least two notches at an outer edge of its major surface;
a substrate bonded to the major surface of the lead frame so that the notches are exposed therearound;
an optical element having an optical axis generally perpendicular to the major surface and bonded onto the substrate using the notches as a positioning reference;
a receptacle housing being in contact with the lead frame to cover the substrate and the optical element, and including a tubular ferrule guide portion having a central axis generally in alignment with the optical axis and guide pins fitted into the notches;
a converging lens having an optical axis generally in alignment with the optical axis of the optical element and fitted to an opening end of the ferrule guide portion; and
an optical fiber with one end portion inserted into the ferrule guide portion so as to be opposed to the converging lens, the optical fiber including a core and a cladding surrounding the core.

9. The module according to claim 8, wherein a first optical element emitting light along a first optical axis and a second optical element receiving light along a second optical axis are bonded onto the substrate to enable bidirectional optical transmission.

10. The module according to claim 8, wherein
the optical element emits light along the optical axis, and
the light is converged by the converging lens and injected into an end surface of the core at one end of the optical fiber at an incident angle of 11.5 degrees or less.

11. The module according to claim 10, wherein the optical element emits light in a visible to infrared wavelength range.

12. The module according to claim 10, wherein the optical element is a surface emitting semiconductor laser.

13. The module according to claim 10, wherein the core has a diameter in a range from 200 to 1000 μm.

14. The module according to claim 8, further comprising:
a back lid sandwiching the lead frame with the receptacle housing.

15. The module according to claim 8, wherein a number of the guide pins is four.

16. The module according to claim 8, further comprising:
a shell being translucent near the optical axis,
an inside space formed by sealing the shell and the substrate being hermetic.

17. A method for manufacturing an optical link module including a lead frame, a substrate bonded onto the lead frame, an optical element bonded onto the substrate, and a receptacle housing being in contact with the lead frame to cover the substrate and the optical element, the method comprising:
bonding the substrate onto a major surface of the lead frame so that notches provided at an outer edge of the major surface of the lead frame are exposed therearound;
bonding the optical element onto the substrate using the notches as a positioning reference; and
fitting guide pins provided in the receptacle housing into the notches so that the central axis of a tubular ferrule guide portion provided in the receptacle housing is generally aligned with the optical axis of the optical element, and fixing the lead frame to the receptacle housing.

18. The method according to claim 17, further comprising:
press-fitting a converging lens into a fitting hole provided at an opening end of the ferrule guide portion and having a tapered cross-sectional shape.

19. The method according to claim 17, wherein the fixing includes pressing the lead frame into the receptacle housing via a back lid to fix its position along the optical axis.

20. The method according to claim 17, wherein the bonding the optical element includes determining the position of the optical element on the basis of the positions of the notches which are optically detected.
